(19) United States
(12) Patent Application Publication
(10) Pub. No.: US 2025/0024500 A1
(43) Pub. Date: Jan. 16, 2025

(54) TECHNIQUES FOR LISTEN BEFORE TALK FAILURE RECOVERY FOR SIDELINK

(71) Applicant: Lenovo (Singapore) Pte. Ltd., New Tech Park (SG)

(72) Inventors: Joachim Löhr, Wiesbaden (DE); Karthikeyan Ganesan, Kronberg im Taunus (DE); Alexander Golitschek Edler von Elbwart, Darmstadt (DE); Prateek Basu Mallick, Dreieich (DE)

(21) Appl. No.: 18/771,900

(22) Filed: Jul. 12, 2024

Related U.S. Application Data
(60) Provisional application No. 63/526,568, filed on Jul. 13, 2023.

(51) Int. Cl. H04W 74/0816; H04W 74/08; H04W 92/18

(52) U.S. Cl. CPC H04W 74/0816; H04W 74/0875; H04W 92/18

(57) ABSTRACT

Various aspects of the present disclosure relate to techniques for listen before talk failure recovery for sidelink. An apparatus includes at least one memory and at least one processor coupled with the at least one memory. The at least one processor is configured to cause the apparatus to detect a consistent LBT failure on a set of resource blocks RBs, perform at least one LBT on the set of RBs, wherein the LBT is performed based on a reference sidelink SL format, increment a counter in response to determining a success for one of the at least one LBT, wherein the counter is associated with the set of RBs, and, in response to determining that the counter satisfies a predefined threshold, cancel the consistent LBT failure.

### TECHNICAL FIELD

The present disclosure relates to wireless communications, and more specifically to consistent listen before talk (LBT) failure recovery procedure for sidelink (SL) operating in a cell with shared spectrum channel access.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include detecting a consistent LBT failure on a set of resource blocks (RBs), performing at least one LBT on the set of RBs, wherein the LBT is performed based on a reference SL format, incrementing a counter in response to determining a success for one of the at least one LBT, wherein the counter is associated with the set of RBs, and, in response to determining that the counter satisfies a predefined threshold, cancelling the consistent LBT failure.

### BRIEF DESCRIPTION OF THE DRAWINGS

FIG. 1 illustrates an example of a wireless communications system in accordance with aspects of the present disclosure.

FIG. 2A illustrates an example of channel access in new radio-unlicensed (NR-U) in accordance with aspects of the present disclosure.

FIG. 2B illustrates an example of a medium access control (MAC) protocol data unit (PDU) in accordance with aspects of the present disclosure.

FIG. 3 illustrates an example of a UE 300 in accordance with aspects of the present disclosure.

FIG. 4 illustrates an example of a processor 400 in accordance with aspects of the present disclosure.

FIG. 5 illustrates an example of a network equipment (NE) 500 in accordance with aspects of the present disclosure.

FIG. 6 illustrates a flowchart of a method performed by a UE in accordance with aspects of the present disclosure.

FIG. 7 illustrates a flowchart of a method performed by a UE in accordance with aspects of the present disclosure.

### DETAILED DESCRIPTION

In LBT, transmitters are expected to “sense” the medium, based on a Clear Channel Assessment (CCA) protocol, and detect transmissions from other nodes prior to transmitting. The simplest CCA method is energy detection, i.e., to measure the received energy level of signals transmitted from other devices and determine whether a channel is idle or busy.

In NR-U when the UE detects consistent uplink LBT failures, it takes actions (e.g., as specified in TS 38.321, incorporated herein by reference). The detection is per Bandwidth Part (BWP) and based on all uplink transmissions within this BWP. When consistent uplink LBT failures are detected on a serving cell, the UE performs the corresponding actions. For cases when SL is operated on a cell configured with shared spectrum, the corresponding UE actions upon detection of consistent LBT failures for SL transmissions on a RB set/resource pool (RP) need to be defined.

For SL unlicensed, once a consistent LBT failure has been declared for an RB set or resource pool, there needs to be a mechanism which defines when UE can use the RB set(s)/RPs again for SL transmissions. In NR-U this functionality was left to gNB implementation. Since the LBT/CCA procedure is used to detect a consistent LBT failure, the LBT procedure is also suitable to check whether/when an RB set can be used (again) for SL transmissions once consistent LBT failure was declared. However, the channel access parameters to be used are at least partly defined based on the data multiplexed in a SL transport block (TB) for which LBT is performed. Since there is no actual SL transmission, e.g., UE doesn't generate a TB, when using the LBT procedure to check whether the consistent LBT failure situation persists or whether RB set can be used again for SL transmissions, it is not clear how UE should perform the LBT procedure.

For cases when UE performs the LBT procedure for an RB set for which consistent LBT failure was declared, UE performs the LBT procedure based on a reference SL format/transmission. For example, a predefined reference channel access priority class (CAPC) value is used for such LBT procedures, e.g., to check whether consistent LBT failure can be cancelled or persists.

According to conventional solutions, a UE would do a short LBT or LBT type 2 in order to check whether an RB set can be used again after having declared consistent LBT failure for the RB set. However, short LBT would not be suitable since the fixed sensing duration will be too short to determine whether the consistent LBT failure situation persists, e.g. 16 μs or 25 μs. The solution described in several embodiments ensures a reliable mechanism to detect whether an RB set for which consistent LBT failure was declared, can be used again for SL transmission.

This disclosure describes techniques to allow for an efficient and reliable recovery of consistent LBT failure for SL transmission on a cell configured with a shared spectrum. In particular, this disclosure provides several solutions disclosed in several embodiments defining a mechanism detailing how UE determines whether an RB set for which consistent LBT failure was declared can be reused for SL transmissions, e.g., consistent LBT failure is cancelled. Furthermore, a procedure to inform a peer (e.g., receiving (RX)) UE(s) about consistent LBT failure is introduced which ensures that SL hybrid automatic repeat request (HARQ) feedback transmissions on physical shared feedback channel (PSFCH) are not impeded for SL transmissions due to consistent LBT failure.

Aspects of the present disclosure are described in the context of a wireless communications system.

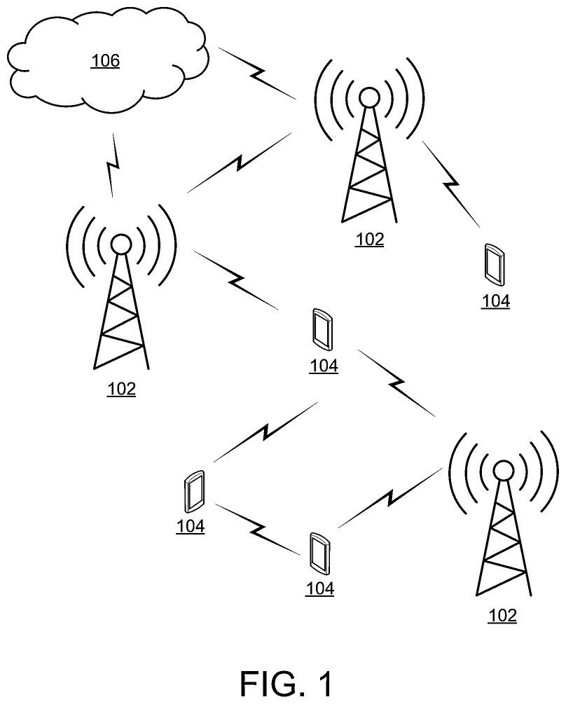

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a SL. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

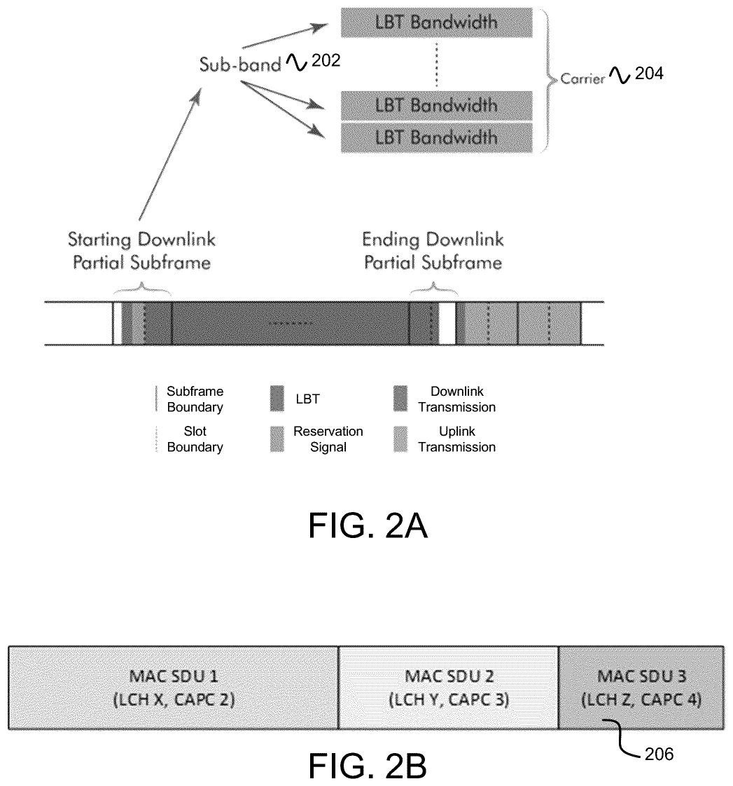

FIG. 2A illustrates an example of channel access in NR-U in accordance with aspects of the present disclosure. In NR-U, channel access in both downlink and uplink rely on the LBT. In such an embodiment, the gNB and/or UE first senses the channel to determine there is no on-going communications prior to any transmission. When a communication channel is a wide bandwidth unlicensed carrier 204, the CCA procedure relies on detecting the energy level on multiple sub-bands 202 of the communications channel. No beamforming is considered for LBT in NR-U in Rel. 16 and only omni-directional LBT is assumed.

Basically, in the NR-U LBT procedures for channel access, both gNB-initiated and UE-initiated channel occupancy times (COTs) use category 4 LBT where the start of a new transmission burst always perform LBT with exponential backoff. Only with exception, the discovery reference signal (DRS) is at most one ms in duration and is not multiplexed with unicast physical downlink shared channel (PDSCH). Furthermore, UL transmission within a gNB initiated COT or a subsequent DL transmission within a UE or gNB initiated COT can transmit immediately without sensing only if the gap from the end of the previous transmission is not more than 16 μs, otherwise category 2 LBT is used, and the gap cannot exceed 25 μs.

As mentioned before, UE/gNB in unlicensed carriers performs LBT operation as required by the regulation, and within Category 4 LBT, several CAPCs are defined to have differentiated channel access parameters (e.g., the following tables are from TS 37.213, incorporated herein by reference).

TABLE 4.1.1-1
CAPC for DL

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, 255, 511, |
| | | | | | 1023} |

TABLE 4.2.1-1
CAPC for UL

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, |
| | | | | | 1023} |
| 4 | 7 | 15 | 1023 | 6 ms or 10 ms | {15, 31, 63, 127, 255, 511, |
| | | | | | 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

For dynamically scheduled Uplink resources, i.e., UL downlink channel information (DCI), gNB indicates the CAPC to be used by the UE for the corresponding Uplink transmission. For uplink configured grant, network cannot signal the CAPC index for every occasion, and thus UE itself has to select which CAPC is used for each occasion. According to the agreements for data radio bearers (DRBs), UE selects the highest CAPC index (lowest priority) of logical channels (LCHs) multiplexed in a TB. In the scenario shown in FIG. 2B, UE will select CAPC 4 206 (i.e. the lowest priority).

With the agreed behavior, it is possible that very small amounts of data belong to the highest CAPC index, like above, but the UE still has to apply the highest CAPC index for the (possibly) high-priority data, which leads to some transmission delays. Therefore, for UL configured grant (CG), if signaling radio bearer (SRB) (data control channel (DCCH)), service data unit (SDU) is included in MAC PDU, UE select the CAPC index of the SRB (DCCH). Otherwise, the UE selects the highest CAPC index (lowest priority) of LCHs multiplexed in MAC PDU. The detailed rules to be used for CAPC setting are further outlined below.

The CAPC of radio bearers and MAC control elements (CEs) are either fixed or configurable-fixed to the lowest priority for the padding BSR and recommended bit rate MAC CEs; fixed to the highest priority for SRB0, SRB1, SRB3 and other MAC CEs; and/or configured by the gNB for SRB2 and DRB.

When choosing the CAPC of a DRB, the gNB takes into account the 5G quality of service (QOS) identifiers (5QIs) of all the QoS flows multiplexed in that DRB while considering fairness between different traffic types and transmissions. Table 5.6.2-1 below shows which CAPC should be used for which standardized 5QIs i.e. which CAPC to use for a given QoS flow. Note, a QoS flow corresponding to a non-standardized 5QI (i.e. operator specific 5Q1) should use the CAPC of the standardized 5QI that best matches the QoS characteristics of the non-standardized 5QI.

TABLE 5.6.2-1
Mapping between Channel Access Priority Classes and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

NOTE:
lower CAPC value means higher priority

When performing CAT4-LBT (Type 1 LBT) for the transmission of an uplink TB (see, e.g., TS 37.213, clause 4.2.1.1) and when the CAPC is not indicated in the DCI, the UE shall select the CAPC if only MAC CE(s) are included in the TB, the highest priority CAPC of those MAC CE(s) is used; if common control channel (CCCH) SDU(s) are included in the TB, the highest priority CAPC is used; if DCCH SDU(s) are included in the TB, the highest priority CAPC of the DCCH(s) is used; or the lowest priority CAPC of the logical channel(s) with MAC SDU multiplexed in the TB is used otherwise.

Regarding SL operation in unlicensed spectrum, in Rel-16, SL communication was developed in RAN mainly to support advanced V2X applications. In Rel-17, SA2 studied and standardized proximity-based service including public safety and commercial related services. As part of Rel-17, power saving solutions (e.g., partial sensing, discontinuous reception (DRX)) and inter-UE coordination have been developed in RAN1 and RAN2 to improve power consumption for battery limited terminals and reliability of SL transmissions.

Although NR SL was initially developed for V2X applications, there is growing interest in the industry to expand the applicability of NR SL to commercial use cases. For commercial SL applications, two key requirements have been identified-increased SL data rate and support of new carrier frequencies for SL.

Increased SL data rate is motivated by applications such as sensor information (video) sharing between vehicles with high degree of driving automation. Commercial use cases could require data rates in excess of what is possible in Rel-17. Increased data rate can be achieved with the support of SL carrier aggregation and SL over unlicensed spectrum.

In one embodiment, as in NR-U, the lowest priority CAPC of the logical channel(s) with MAC SDU multiplexed in the TB is used regardless of whether the TB also contains SL MAC CEs in addition to MAC SDUs.

In one embodiment, for an IDLE/INACTIVE/OOC UE, if a QoS flow cannot be mapped to a non-default SL resource block (SLRB): 1) if the per-bearer CAPC is configured in system information block (SIB)/Pre-configuration, the UE uses the configured CAPC; 2) else, select CAPC of the standardized PC5 QOS identifier (PQI) that best matches the QoS characteristics of the non-standardized QoS flow based on one or more QoS characteristics. For a standardized QoS flow, CAPC is directly derived from CAPC table.

In one embodiment, the UE can select 1) either to do a changed-LCP, in order to satisfy the COT requirement, and to do the type-2 LBT or 2) to do a legacy-LCP, e.g. using type-1, type-2 LBT.

In one embodiment, RAN2 deprioritizes the SL DRX enhancement on active time extension for SL LBT failure. In such an embodiment, shared COT as SL DRX active time is not defined and if multiple PSFCH occasions per PSCCH/PSSCH is supported in RAN1, if HARQ A/N is successfully transmitted in one PSFCH occasion, Rx UE starts the sl-drx-HARQ-RTT-Timer for the corresponding SL process in the first slot after the end of the corresponding PSFCH transmission carrying the SL HARQ feedback. In one embodiment, if multiple PSFCH occasions per PSCCH/PSSCH is supported in RAN1, if LBT failure happens in all PSFCH occasions, Rx UE starts the sl-drx-HARQ-RTT-Timer for the corresponding SL process in the first slot after the end of the last PSFCH occasion for the SL HARQ feedback.

In one embodiment, for SL CG, CG retransmission timer in SL-U is not supported. In further embodiments, in RAN2, the UE triggers a resource (re) selection when PSSCH transmission is not performed due to an LBT failure indication from L1. In one embodiment, in RAN2, L1 handles LBT impact to/from other UEs' reserved resources in SL candidate resource selection (inter-UE case).

In one embodiment, for type-1 LBT, if UE observes buffer status change after LBT initiation (i.e., before MAC PDU generation), which leads to a higher CAPC priority than the value used for type-1 LBT, it's left to UE implementation how to handle this case (like NR-U).

According to one embodiment, a UE performs an LBT procedure for a predefined SL format/transmission without having generated a SL transport block and without performing an actual SL transmission-if LBT is successful. According to one implementation of the embodiment, a UE (e.g., SL Tx UE), performs the LBT procedure according to a reference SL format/transport block. In one example, there is a predefined reference CAPC value which is assumed/used for the LBT procedure performed by the UE when not having generated a TB for a SL transmission. According to another example, a predefined contention window length is used for the LBT procedure. According to another implementation, the predefined maximum Contention Window (CW) value, potentially depending on a predefined reference CAPC value p, is used for the virtual LBT which is used to draw a random number, e.g. between 0 and CW.

In the following, the procedure of performing an LBT procedure based on a reference SL transmission/format (when there is no actual SL transmission) is also referred to as virtual LBT procedure. In one example the energy detection threshold used during the virtual CCA/LBT procedure, e.g. energy detection threshold (EDT) used to determine whether the channel is considered as busy or free, is preconfigured, e.g. a reference EDT is used for determining whether consistent LBT can be cancelled. The reference EDT value may depend on a reference bandwidth, e.g. resulting in a higher EDT value for a higher reference bandwidth.

According to one aspect of the embodiment, a UE (e.g., Tx UE) doesn't perform an actual SL transmission even for cases when virtual LBT procedure is successful. The motivation for a virtual LBT procedure is to check whether a set of RB(s) or a RP pool is available again for SL transmissions, e.g. whether a UE can acquire or initiate a COT within the set of RB(s) or RP, after a consistent LBT failure has been detected/declared for the RB set(s)/RP. In one example the virtual LBT is a type 1 LBT.

According to another exemplary implementation of the embodiment, the UE senses the channel for a fixed predefined period when performing a virtual LBT procedure. Here the predefined sensing period is different to the sensing period defined for LBT type 2 (16 μs or 25 μs). In one example, the UE cancels the consistent LBT failure for the RB set/RP if the virtual LBT is successful, e.g. if the channel is sensed as free.

According to one embodiment, a UE performs an LBT procedure, e.g. virtual LBT, on an RB set or RP a specific time after having detected/declared consistent LBT failure for that RB set or RP, e.g. virtual LBT is not performed immediately after having declared consistent LBT failure but after some time offset. In one example, the time is fixed in specifications or preconfigured. According to another exemplary implementation of the embodiment, the specific time is a backoff time determined by the UE, e.g. UE draws a random value, e.g. integer value, N between 0 and predefined maximum value, which determines the waiting time.

According to one embodiment, a UE performs an LBT procedure a predefined number of times during a predefined time window on a specific set of RB(s) or sub-channels or resource pool even though the UE doesn't intend to make a SL transmission on the set of RB(s)/sub-channels/RP on which the LBT is performed, e.g. virtual LBT is performed a predefined number of times by the UE. According to one implementation of the embodiment, a UE cancels the Consistent LBT failure detected/declared for an RB set or RP, once a predefined number of successful (virtual) LBT(s) have been performed by the UE during the preconfigured time window. According to one implementation of the embodiment, the one or more LBT procedures performed during the time window are independent LBT processes, e.g., each LBT process is a virtual LBT determined based on a reference SL format/transmission (no dependencies between the different virtual LBT processes). In one example the UE maintains a new counter, which counts the number of successful (virtual) LBT procedures during the time window.

In one example, UE performs the LBT procedures at predefined occasions within the time window. In one example, the UE cancels a Consistent LBT failure detected/declared for an RB set or RP, once a predefined ratio of LBT successes over LBT attempts have been reached by the UE during the preconfigured time window on the RB set or RP (for which consistent-LBT failure was declared). A UE can use the RB set/RP for SL transmission once a consistent LBT failure is cancelled. In one example, the LBT attempts are virtual LBT type 1. According to another implementation of the embodiment, UE performs LBT type 2 attempts for checking whether a consistent LBT failure can be cancelled.

According to one implementation of the embodiment, a UE is configured with a new timer that controls the time window during which UE performs one or more LBT procedures to determine whether a consistent LBT failure can be cancelled. In one example, the timer is started a predefined time offset after having declared consistent LBT failure for an RB set. The timer is maintained per RB set in one specific implementation. While the new timer is running, the UE performs a predefined number of LBT procedures, e.g., virtual LBT procedure as outlined above, to check whether it can get access to the channel for SL transmissions, e.g., to check whether the consistent LBT failure situation persists or whether access to the channel is possible.

In one example, the timer is the lbt-FailureDetectionTimer used within the LBT failure detection and recovery procedure. In one embodiment, discussed for example in TS38.321 (incorporated herein by reference) the MAC entity may be configured by RRC with a consistent LBT failure recovery procedure. Consistent LBT failure is detected per UL BWP by counting LBT failure indications, for all UL transmissions, from the lower layers to the MAC entity.

In one embodiment, RRC configures the following parameters in the lbt-FailureRecoveryConfig—Ibt-FailureInstanceMaxCount for the consistent LBT failure detection and Ibt-FailureDetectionTimer for the consistent LBT failure detection.

In one embodiment, the following UE variable is used for the consistent LBT failure detection procedure—LBT_COUNTER (per Serving Cell), which is a counter for LBT failure indication which is initially set to 0.

In one embodiment, for each activated Serving Cell configured with lbt-FailureRecoveryConfig, the MAC entity shall, if LBT failure indication has been received from lower layers, start or restart the lbt-FailureDetectionTimer, increment LBT_COUNTER by 1, if LBT_COUNTER>=Ibt-FailureInstanceMaxCount, trigger consistent LBT failure for the active UL BWP in this Serving Cell. If the Serving Cell is the SpCell and if consistent LBT failure has been triggered in all UL BWPs configured with PRACH occasions on same carrier in this Serving Cell, indicate consistent LBT failure to upper layers; otherwise, stop any ongoing Random Access procedure in this Serving Cell, switch the active UL BWP to a UL BWP, on same carrier in this Serving Cell, configured with PRACH occasion and for which consistent LBT failure has not been triggered, and initiate a Random Access Procedure (as specified in clause 5.1.1).

In one embodiment, if all triggered consistent LBT failures are cancelled in this Serving Cell or if the lbt-FailureDetectionTimer expires or if Ibt-FailureDetectionTimer or lbt-FailureInstanceMaxCount is reconfigured by upper layers, set LBT_COUNTER to 0.

In one embodiment, the MAC entity shall, if consistent LBT failure has been triggered, and not cancelled, in the SpCell and if UL-SCH resources are available for a new transmission in the SpCell and these UL-SCH resources can accommodate the LBT failure MAC CE plus its subheader as a result of logical channel prioritization, instruct the Multiplexing and Assembly procedure to generate the LBT failure MAC CE. Otherwise, if consistent LBT failure has been triggered, and not cancelled, in at least one SCell and if UL-SCH resources are available for a new transmission in a Serving Cell for which consistent LBT failure has not been triggered and these UL-SCH resources can accommodate the LBT failure MAC CE plus its subheader as a result of logical channel prioritization, instruct the Multiplexing and Assembly procedure to generate the LBT failure MAC CE. Otherwise, trigger a Scheduling Request for LBT failure MAC CE.

In one embodiment, if a MAC PDU is transmitted and LBT failure indication is not received from lower layers and this PDU includes the LBT failure MAC CE, cancel all the triggered consistent LBT failure(s) in SCell(s) for which consistent LBT failure was indicated in the transmitted LBT failure MAC CE.

In one embodiment, if consistent LBT failure is triggered and not cancelled in the SpCell and if the Random Access procedure is considered successfully completed (see clause 5.1) in the SpCellm cancel all the triggered consistent LBT failure(s) in the SpCell.

In one embodiment, if Ibt-FailureRecoveryConfig is reconfigured by upper layers for a Serving Cellm cancel all the triggered consistent LBT failure(s) in this Serving Cell.

In one implementation of the embodiment, a UE starts the lbt-FailureDetectionTimer associated with an RB set/RP some predefined time offset after having declared a consistent LBT failure for the RB set or RP. The predefined offset may be Oms, e.g. no time offset. The UE performs a predefined number of LBT procedures/attempts, e.g. virtual LBT procedures, on the RB set/RP to check whether it can successfully access the shared spectrum/channel. In case the (virtual) LBT procedure is not successful, e.g. LBT failure occurred, UE still considers the consistent LBT failure situation as persistent. In one example UE (re) starts the lbt-FailureDetectionTimer after a predefined time offset and repeats the procedure, e.g. performing virtual LBT procedure. In case the lbt-FailureDetectionTimer expires, e.g. no LBT failure during the time period where lbt-FailureDetectionTimer is running, UE cancels the consistent LBT failure for the corresponding RB set/RP.

According to one embodiment, a UE performs a virtual LBT procedure on an RB set/RP, for which consistent LBT failure has been detected/declared, for a SL TB that has been generated for a SL grant on a different RB set/RP. Instead of performing a virtual LBT procedure for a reference SL format/transmission, according to this embodiment a UE is performing a virtual LBT for an actual SL TB which was generated for a SL grant on a different RB set/RP. Similar to the above embodiments, UE is not performing an actual SL transmission on the RB set/RP on which the virtual LBT is carried out, e.g. the LBT is only done for the purpose of checking whether the consistent LBT failure situation persists. In one example, a UE cancels the consistent LBT failure if the virtual LBT for the SL TB (generated for a SL grant on a different RB set) was successful.

According to one embodiment, a UE performs a predefined number of SL channel busy ratio (CBR) measurements, e.g. UE performs SL CBR measurements in a predefined number of slots, after having declared SL consistent-LBT failure for an RB set or RP. In case the SL CBR measured by the UE exceeds a predefined threshold, the channel is considered busy, e.g. UE cannot access the channel for SL transmission. For cases when a certain number of SL CBR measurements of the predefined number of SL CBR measurement performed by the UE or a certain ratio of the SL CBR measurements performed by the UE for an RB set/RP is below a predefined threshold, UE cancels the consistent LBT failure for the corresponding RB set/RP.

According to one implementation of the embodiment, a UE measures the SL Received Signal Strength Indicator (RSSI) only for the sub-channels which are part of the RB set for which UE checks whether consistent LBT failure situation persists or whether consistent LBT failure can be cancelled. There is no need to measure the SL RSSI for all sub-channels in an RP when UE checks the LBT failure status of an RB set. In one example the CBR measurement window for the SL CBR is configured by another higher layer parameter for cases where the CBR measurement is used to determine whether SL Consistent LBT failure can be cancelled or not. As shown below, in the legacy UE measures the CBR measurement is done over a CBR measurement window [n-a, n-1], wherein a is equal to 100 or 100·2^{μ} slots, according to higher layer parameter sl-Time WindowSizeCBR. For Consistent LBT failure clearance/cancellation the measurement window may be configured to a smaller window size/length.

According to one implementation of the embodiment, a UE measures the RSSI including any transmissions (e.g. SL, Uu, Wifi transmissions, etc.) to determine whether the consistent LBT failure can be cancelled or whether the channel is still considered as busy. This would indicate a generalized G-CBR compared to the CBR definition quoted below. As outlined above, UE may perform (G-)CBR measurements in a predefined number of slots, after having declared SL consistent-LBT failure for an RB set or RP. In case the (G-)-CBR measured by the UE exceeds a predefined threshold, the channel is considered busy, e.g. UE cannot access the channel for SL transmission. For cases when a certain number of (G-)CBR measurements of the predefined number of (G-)CBR measurement performed by the UE or a certain ratio of the (G-)CBR measurements performed by the UE for an RB set/RP is below a predefined threshold, UE cancels the consistent LBT failure for the corresponding RB set/RP.

In one embodiment, SL CBR measured in slot n is defined as the portion of sub-channels in the resource pool whose SL RSSI measured by the UE exceeds a (pre-) configured threshold sensed over a CBR measurement window [n-a, n-1], wherein a is equal to 100 or 100·2μ slots, according to higher layer parameter sl-TimeWindowSizeCBR. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used. In one embodiment, this is applicable for RRC_IDLE intra-frequency, RRC_IDLE inter-frequency, RRC_CONNECTED intra-frequency, and RRC_CONNECTED inter-frequency.

According to one embodiment, a SL UE is allowed to use a shared COT, e.g., COT was initiated by another SL UE and shared with the SL U, even for cases that the SL transmission is carried out in RB(s), which are pat of an RB set/RP for which consistent LBT failure was declared. If a SL UE satisfies the CAPC and destination restrictions associated with the shared COT, e.g., SL transmission satisfies the CAPC and destination restrictions associated with the shared COT, and Type 2 LBT is successful, the SL UE is allowed to perform a SL transmission within a shared COT even though the transmission occurs on an RB set/RP for which consistent LBT failure was declared before.

According to one embodiment, an SL UE informs the peer UE(s)/entities(s) about a consistent LBT failure detected for RB set(s)/RP by means of new control signaling. Since the UE may not be able to send PSFCH (HARQ feedback) on the RB set(s)/RP for which consistent LBT failure was detected it is important to inform the peer UE(s) about this event. According to one implementation of the embodiment, a UE in response to receiving a Consistent LBT failure notification from a Rx UE, does not schedule any PSSCH transmissions on the RB set(s)/RP(s) for which the Rx UE reported a consistent LBT failure.

In one example, a UE, e.g. Rx UE, informs all peer UEs about the detected C-LBT failure(s) for an RB set/RP for which it is performing PSFCH transmissions, e.g. sending HARQ feedback on PSFCH for the PSSCH transmission from the corresponding peer UEs. According to one implementation of the embodiment, the MAC CE which is used for informing gNB about consistent LBT failure on the Uu interface, e.g. for mode 1 resource allocation as well as mode 2, is sent over the PC5 interface to the peer UE(s).

In one example, the new SL MAC CE has the highest priority during LCP procedure. According to another exemplary implementation the new SL MAC CE is linked to a SR configuration, e.g. for mode 1 resource allocation.

As used herein, the term “peer UE(s)” refers to other SL UE(s) a SL UE is in communication with. For example, for the case of unicast a peer UE refers to a UE with which the SL UE has a unicast connection. It will be similarly applicable to groupcast communication, i.e. a peer UE is any UE with which the SL UE has a groupcast connection. The term “peer UE” may be also replaced by Rx UE.

According to one implementation of the embodiment, a UE triggers the transmission of inter-UE coordination (IUC) information for cases when consistent LBT failure has been detected/declared for an RB set/RP. Within the IUC information UE informs its peer UE(s) that it cannot send PSFCH on a specific RB set/RP. In one example the detection of consistent LBT failure is a new trigger for the transmission of IUC information. According to one specific implementation one of the reserved bits of the Inter-UE Coordination Information MAC CE is used to indicate that consistent LBT failure has been detected for an RB set/RP.

According to one implementation of the embodiment, the new SL consistent LBT failure notification is sent by PC5 RRC signaling, e.g. new PC5-RRC message.

According to one implementation of the embodiment, a UE informs its peer UE(s) when a SL consistent LBT failure has been cancelled, e.g. RB set(s)/RP can be used for PSFCH transmissions. In one example, a UE also informs the gNB when a consistent LBT failure has been cancelled, e.g. for mode 1 resource allocation.

According to one embodiment, a UE maps only LCHs for which HARQ feedback is disabled on RB set(s)/RP(s) for which the corresponding Rx UE has detected and reported a consistent LBT failure. According to one implementation of the embodiment a new LCH restriction is introduced which considers also the LBT status of the RB set/RP of a peer Rx UE when performing the LCP/destination selection procedure. This LCH restriction is applied by the Tx UE in response to receiving information that the corresponding peer (Rx) UE cannot send PSFCH for a PSSCH/PSCCH transmission due to consistent LBT failure.

In one example the LCH restriction is only temporarily applied, e.g. as long as the RB set is indicated as blocked due to consistent-LBT failure. Once the Rx UE indicates that the RB set can be used again for PSFCH transmission, e.g., consistent LBT failure has been cancelled, the LCH restriction is no longer applied during the LCP procedure. In one example, Tx UE considers the LBT status of an RB set, as seen from the RX UE(s), when determining whether HARQ feedback can be used for a PSSCH transmission on an RB set.

The HARQ transmission mode is selected by the Tx UE based on the LBT status (from Rx UE perspective) of the RB set on which the PSSCH transmission takes place. According to one implementation of the embodiment, UE considers the LBT status (as reported/detected from Rx UE(s)) of an RB set during the resource (re)selection procedure. In one example, a UE selects SL resources on an RB set for which no consistent LBT failure was reported by Rx UE(s) for cases when the PSSCH is configured with HARQ feedback.

According to one embodiment, the UE prioritizes destination(s) during the LCP/destination selection procedure for which no consistent LBT failure was reported. According to one implementation of the embodiment, the UE shall only select a destination for an SL grant (for an initial transmission) on an RB set/RP for which the corresponding destination has not reported a consistent LBT failure.

In one embodiment, in the destination selection procedure, which is part of the LCP procedure, a UE selects a destination which is in DRX ActiveTime for the SL transmission occasion (SL grant). Similarly, in one embodiment, a UE selects a destination for a SL transmission occasion for which the destination didn't detect/report a consistent LBT failure. According to one specific implementation of the embodiment, the UE selects a destination for a SL transmission occasion for which the destination didn't detect/report a consistent LBT failure if the SL TB which is to be transmitted on the SL transmission occasion uses the “HARQ feedback enabled” transmission mode.

In one example, the additional LCH restriction and enhanced destination selection procedure, e.g. considering the LBT status of the RB set/RP during LCP/destination selection, should be applied regardless of the cast type. For unicast connections, the Tx UE considers the LBT status of the peer Rx UE when performing the LCP procedure, whereas for groupcast transmission, Tx UE has to take into account the LBT status of the RB set/RP for all group member UEs. According to one exemplary implementation of the embodiment, the UE considers only LCHs configured with HARQ feedback disabled for a groupcast transmission on an RB set, if at least one of the group member Rx UEs reported a consistent LBT failure for the RB set. In such an embodiment, a Tx UE schedules PSSCH transmissions configured with HARQ feedback enabled on other RB set(s) for which no consistent LBT failure was reported by the group member Rx UE(s).

In another implementation, a UE applies the additional LCH restriction during LCP, e.g. multiplexing only data of LCH(s) configured with HARQ feedback disabled on an SL grant, for a PSSCH transmission on an RB set if a predefined number of group member RX UEs or a predefined ratio of the group member UEs have reported a consistent LBT failure for the corresponding RB set.

Regarding the selection of logical channels, a MAC entity shall, for each SL channel information (SCI) corresponding to a new transmission, if sl-BWP-DiscPoolConfig or sl-BWP-DiscPoolConfigCommon is configured (e.g., according to TS 38.331, incorporated herein by reference) and if the new transmission is associated to a SL grant in sl-DiscTxPoolSelected or sl-DiscTxPoolScheduling configured in sl-BWP-DiscPoolConfig or sl-BWP-DiscPoolConfigCommon, select a Destination associated with NR SL discovery, e.g., as specified in TS 23.304 (incorporated herein by reference), that is in the SL Active time for the SL transmission occasion if SL DRX is applied for the destination, and among the logical channels that satisfy the following conditions for the SL grant associated to the SCI-SL data for NR SL discovery is available for transmission, SBj>0, in case there is any logical channel having SBj>0, sl-configuredGrantType1Allowed, if configured, is set to true in case the SL grant is a Configured Grant Type 1, and sl-AllowedCG-List, if configured, includes the configured grant index associated to the SL grant.

Otherwise, if the new transmission is not associated to a SL grant in sl-DiscTxPoolSelected or sl-DiscTxPoolScheduling configured in sl-BWP-DiscPoolConfig or sl-BWP-DiscPoolConfigCommon, the MAC entity selects a Destination associated with one of unicast, groupcast and broadcast (excluding the Destination(s) associated with NR SL discovery, e.g., as specified in TS 23.304 (incorporated herein by reference)), that is in the SL Active time for the SL transmission occasion if SL DRX is applied for the destination, and having at least one of the MAC CE and the logical channel with the highest priority, among the logical channels that satisfy the following conditions and MAC CE(s), if any, for the SL grant associated to the SCI-SL data for NR SL communication is available for transmission, SBj>0, in case there is any logical channel having SBj>0, sl-configuredGrantType1Allowed, if configured, is set to true in case the SL grant is a Configured Grant Type 1, sl-AllowedCG-List, if configured, includes the configured grant index associated to the SL grant, and sl-HARQ-FeedbackEnabled is set to disabled, if PSFCH is not configured for the SL grant associated to the SCI.

In one embodiment, if sl-BWP-DiscPoolConfig or sl-BWP-DiscPoolConfigCommon is not configured (e.g., according to TS 38.331, incorporated herein by reference), the MAC entity selects a Destination associated to one of unicast, groupcast and broadcast, that is in the SL Active time for the SL transmission occasion if SL DRX is applied for the destination, and having at least one of the MAC CE and the logical channel with the highest priority, among the logical channels that satisfy the following conditions and MAC CE(s), if any, for the SL grant associated to the SCI—SL data is available for transmission, SBj>0, in case there is any logical channel having SBj>0, sl-configuredGrantType1Allowed, if configured, is set to true in case the SL grant is a Configured Grant Type 1, sl-AllowedCG-List, if configured, includes the configured grant index associated to the SL grant, sl-HARQ-FeedbackEnabled is set to disabled, if PSFCH is not configured for the SL grant associated to the SCI.

It is noted that, in one embodiment, if multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.

According to one embodiment, a first UE cancels SL resources reserved by a second UE on an RB set/RP for which the second UE has reported a consistent LBT failure. According to one implementation of the embodiment, a first UE cancels, in response to the reception of a MAC CE indicating RB set(s)/RP(s) for which consistent LBT failure was detected by a second UE, SL resources which were reserved by the second UE on the RB set(s)/RP(s) for which C-LBT was reported. In one example the first UE considers those (formerly) reserved SL resources as available SL resources, e.g., potential candidate resources for SL resource (re) selection. According to another implementation of this embodiment, a first UE is allowed to pre-empt SL resources reserved by a second UE on an RB set/RP for which the second UE has reported a consistent LBT failure, i.e., for which the first UE has received a consistent LBT failure indication by the second UE. The pre-emption can be done regardless of the priority of the SL data to be transmitted on the (pre-empted) resources.

According to one embodiment, a UE deactivates an SL carrier for SL transmissions upon having detected/declared consistent LBT failure for all RB set(s)/Resource pool(s)/BWP(s) within this Tx carrier. According to one implementation of this embodiment UE switches to another TX carrier for SL transmission(s) upon having deactivated the current active TX carrier. For cases when UE applies SL carrier aggregation, UE informs the peer (Rx) UE when deactivating a SL carrier due to consistent LBT failure having been declared for all RB set(s)/RP(s)/BWP(s) on that component carrier (CC). In one example, a Tx UE informs the Rx UE about the carrier deactivation by means of RRC signaling, e.g., new RRC message. In another implementation, a new MAC CE is used to inform the peer RX UE about a deactivated carrier. According to one implementation of the embodiment, Tx UE informs the Rx UE when the carrier is used again for SL transmissions after the SL carrier was deactivated for SL transmissions due to consistent LBT failure.

In one exemplary implementation of the embodiment, a new SL MAC CE is used to indicate the deactivation/activation of a SL carrier. In one example the SL carrier activation/deactivation MAC CE is identified by a MAC subheader with a reserved LCID, which has a fixed size and consists of e.g., a single octet containing seven C-fields and one R-field. If there is SL carrier configured for the MAC entity with a SLcarrierindex i, this field indicates the activation/deactivation status of the SL carrier with SLcarrierindex i, else the MAC entity shall ignore the Cᵢ field. The Cᵢ field is set to 1 to indicate that the SL carrier with SLcarrierIndex i shall be activated. The Cᵢ field is set to 0 to indicate that the SL carrier with SLcarrierIndex i shall be deactivated.

According to one implementation of the embodiment, a UE informs the gNB about the deactivation/activation of an SL carrier. A new MAC CE is introduced to signal the activation/deactivation status of SL carrier(s). For mode 1 resource allocation, a gNB considers the activation/deactivation status of SL carrier(s) for the future SL scheduling. In one example, the SL carrier activation/deactivation MAC CE sent on Uu (Uplink) to the gNB is identified by a MAC subheader with a reserved LCID. In one example, an SR configuration is associated with the new Uu MAC CE, e.g., a UE triggers an SR for cases that the MAC CE was triggered but UE has no available UL grant/PUSCH resources.

According to one embodiment, a UE deactivates a SL carrier in response to the number of consecutive DTX, e.g., PSFCH reception is absent at the corresponding PSFCH reception occasion, satisfies a predefined threshold. For cases that (configured) SL carriers are deactivated, e. g., due to number of consecutive DTX reaching a predefined threshold for each SL carrier, a UE triggers SL radio link failure (RLF), e.g., UE/MAC indicates HARQ-based SL RLF detection to RRC.

According to one implementation of the embodiment, a UE informs its peer (Rx) UE(s) about a deactivated SL carrier by means of new control signaling. For cases when UE applies SL carrier aggregation, the UE informs the peer (Rx) UE when deactivating a carrier due to consecutive DTX detection. In one example, a Tx UE informs the Rx UE about the Carrier deactivation by means of RRC signaling, e.g., a new RRC message. In another implementation, a new MAC CE is used to inform the peer RX UE about a deactivated CC. According to one implementation of the embodiment, Tx UE informs the Rx UE when the CC is used again for SL transmission after the CC was deactivated for SL transmission due to consistent LBT failure.

In one implementation of the embodiment, a new SL MAC CE is used to indicate the deactivation/activation of a SL carrier. In one example, the SL carrier activation/deactivation MAC CE is identified by a MAC subheader with a reserved LCID, which has a fixed size and consists of e.g., a single octet containing seven C-fields and one R-field. If there is SL carrier configured for the MAC entity with a SLcarrierindex i, this field indicates the activation/deactivation status of the SL carrier with SLcarrierindex i, else the MAC entity shall ignore the Cᵢ field. The Cᵢ field is set to 1 to indicate that the SL carrier with SLcarrierIndex i shall be activated. The Cᵢ field is set to 0 to indicate that the SL carrier with SLcarrierIndex i shall be deactivated.

According to one implementation of the embodiment, the UE informs the gNB about the deactivation of a SL carrier in case the number of consecutive DTX reaching a predefined threshold for the SL carrier. A new MAC CE is introduced to signal the activation/deactivation status of SL carrier(s). For mode 1 resource allocation, the gNB considers the activation/deactivation status of SL carrier(s) for the future SL scheduling. In one example the SL carrier activation/deactivation MAC CE sent on Uu (Uplink) to the gNB is identified by a MAC subheader with a reserved LCID. In one example, an SR configuration is associated with the new Uu MAC CE, e.g., UE triggers an SR for cases that the MAC CE was triggered but UE has no available UL grant/PUSCH resources.

According to one embodiment, a UE increases the counter counting the number of consecutive DTX on PSFCH reception occasions by one for cases that multiple PSFCH occasions are configured for a PSSCH transmission, and the UE received DTX on all of those multiple PSFCH occasions. In one example the counter is the sl-maxNumConsecutiveDTX. Increasing the counter once for the case of receiving DTX on multiple configured PSFCH occasions reflects the channel situation better. In case UE increments the counter for each of the multiple PSFCH occasion, there is a risk that RLF may be triggered too early.

According to an embodiment, detecting/declaring a consistent LBT failure for an RB set, RP, or deactivating of an SL carrier as a result of consistent LBT failure, triggers a C-LBT cancellation procedure at the UE. The term “triggering a consistent LBT cancellation procedure,” as used herein, should be generally understood as the procedure to determine whether/when the RB set/RP for which consistent LBT failure was detected/declared can be used (again) for SL transmissions. In other words, triggering a consistent LBT cancellation procedure, is referring to the process/procedure where UE checks whether the conditions for consistent LBT failure cancellation/clearance have been met.

Regarding HARQ-based SL RLF detection, the HARQ-based SL RLF detection procedure is used to detect SL RLF based on a number of consecutive DTX on PSFCH reception occasions for a PC5-RRC connection. In one embodiment, RRC configures the sl-maxNumConsecutiveDTX parameter to control HARQ-based SL RLF detection. IN one embodiment, the UE variable numConsecutiveDTX, which is maintained for each PC5-RRC connection, is used for HARQ-based SL RLF detection.

In one embodiment, the SL HARQ Entity shall (re-) initialize numConsecutiveDTX to zero for each PC5-RRC connection which has been established by upper layers, if any, upon establishment of the PC5-RRC connection or (re) configuration of sl-maxNumConsecutiveDTX.

In one embodiment, the SL HARQ Entity shall for each PSFCH reception occasion associated to the PSSCH transmission, if PSFCH reception is absent on the PSFCH reception occasion, increment numConsecutiveDTX by 1, and if numConsecutiveDTX reaches sl-maxNumConsecutiveDTX, indicate HARQ-based SL RLF detection to RRC. Otherwise, if PSFCH reception is present on the PSFCH reception occasion, re-initialize numConsecutiveDTX to zero.

According to one embodiment, a first UE requests a status report for the HARQ processes from a second UE. According to one implementation of the embodiment, the first and the second UE are SL UEs, which are communicating with each other over a PC5 interface. The first UE is in one example a Tx UE whereas the second UE is in one example a Rx UE. Due to LBT failures, the Rx UE (second UE) may not be able to send HARQ feedback on PSFCH for a PSSCH/PSCCH transmission to the first (Tx UE).

To avoid unnecessary retransmission by the Tx UE, e.g., for cases when DTX is received on PSFCH transmission occasions for a PSSCH transmission and the DTX is interpreted as a NACK, the first UE explicitly requests a HARQ status report from the second (Rx) UE. The request may be a field in a SCI, e.g., PSCCH. In one example a one-bit field may indicate to a Rx UE whether a HARQ status report is requested or not.

According to one implementation of the embodiment, a RX UE receiving a request for a HARQ status report, e.g., within a SCI, may trigger the transmission of a HARQ status report. In one example the HARQ status report is transmitted within a MAC CE and is comprised of a HARQ status for each of the HARQ processes used by the Rx UE for SL communication with the destination that requested the HARQ status report. In one implementation, the HARQ status indicates the last HARQ feedback generated for the HARQ process. In another implementation, the HARQ status indicates whether a further retransmission is requested for a HARQ process. For cases when PSFCH transmissions are not possible due to LBT issues, it may be beneficial to request/trigger a HARQ status report, e.g., Tx UE can trigger an Rx UE to report the feedback for all HARQ processes that are used for the source-destination pair in one report. The HARQ status report could be sent on a different RB set/RP that is not subject to frequent LBT failures.

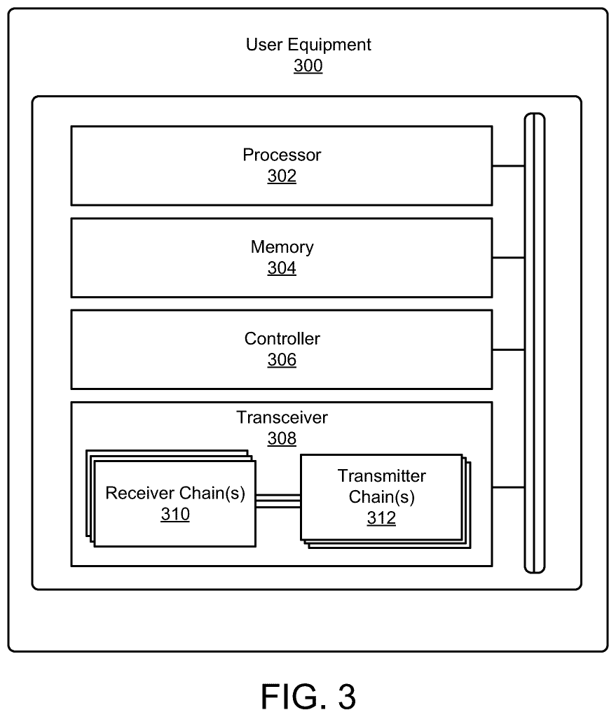

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to support a means for detecting a consistent LBT failure on a set of RBs, performing at least one LBT on the set of RBs, wherein the LBT is performed based on a reference SL format, incrementing a counter in response to determining a success for one of the at least one LBT, wherein the counter is associated with the set of RBs, and, in response to determining that the counter satisfies a predefined threshold, cancelling the consistent LBT failure.

In one embodiment, the reference SL format is comprised of a predefined channel access priority class. In one embodiment, the LBT based on a reference SL format is comprised of a fixed sensing duration. In one embodiment, the at least one LBT that is performed on the set of RBs based on the reference SL format is performed during a time window. In one embodiment, the time window begins a predefined time offset after having declared consistent LBT failure for the set of RBs. In one embodiment, the at least one LBT is performed at predefined occasions during the time window.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control

information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

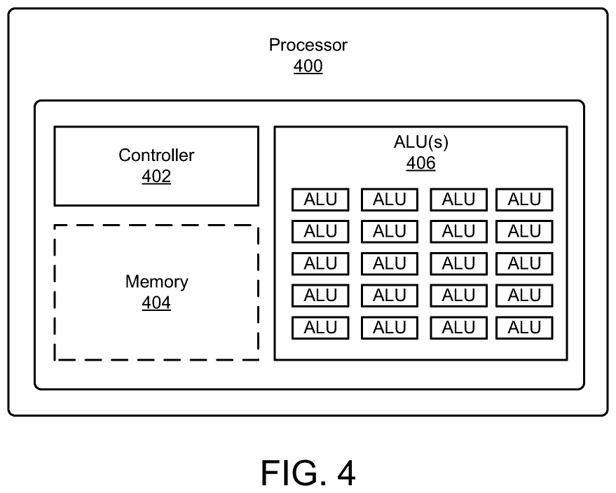

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support a means for detecting a consistent LBT failure on a set of RBs, performing at least one LBT on the set of RBs, wherein the LBT is performed based on a reference SL format, incrementing a counter in response to determining a success for one of the at least one LBT, wherein the counter is associated with the set of RBs, and, in response to determining that the counter satisfies a predefined threshold, cancelling the consistent LBT failure.

In one embodiment, the reference SL format is comprised of a predefined channel access priority class. In one embodiment, the LBT based on a reference SL format is comprised of a fixed sensing duration. In one embodiment, the at least one LBT that is performed on the set of RBs based on the reference SL format is performed during a time window. In one embodiment, the time window begins a predefined time offset after having declared consistent LBT failure for the set of RBs. In one embodiment, the at least one LBT is performed at predefined occasions during the time window.

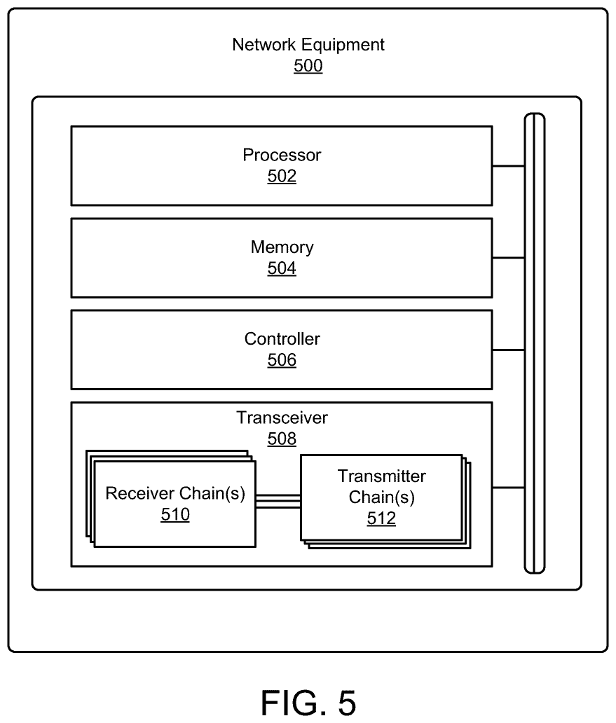

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502, cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control

information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

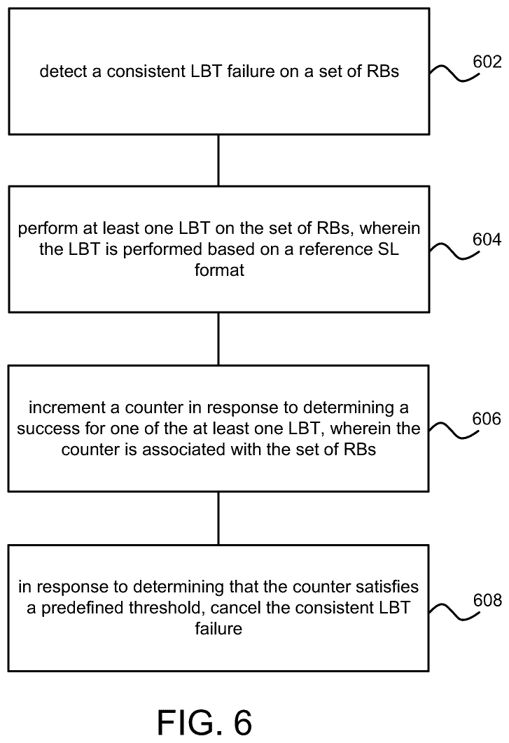

FIG. 6 illustrates a flowchart of a method in accordance with aspects of the present disclosure. The operations of the method may be implemented by a UE as described herein. In some implementations, the UE may execute a set of instructions to control the function elements of the UE to perform the described functions.

At 602, the method may include detecting a consistent LBT failure on a set of RBs. The operations of 602 may be performed in accordance with examples as described herein. In some implementations, aspects of the operations of 602 may be performed by a UE as described with reference to FIG. 3.

At 604, the method may include performing at least one LBT on the set of RBs, wherein the LBT is performed based on a reference SL format. The operations of 604 may be performed in accordance with examples as described herein. In some implementations, aspects of the operations of 604 may be performed by a UE as described with reference to FIG. 3.

At 606, the method may include incrementing a counter in response to determining a success for one of the at least one LBT, wherein the counter is associated with the set of RBs. The operations of 606 may be performed in accordance with examples as described herein. In some implementations, aspects of the operations of 606 may be performed a UE as described with reference to FIG. 3.

At 608, the method may include, in response to determining that the counter satisfies a predefined threshold, cancelling the consistent LBT failure. The operations of 608 may be performed in accordance with examples as described herein. In some implementations, aspects of the operations of 608 may be performed a UE as described with reference to FIG. 3.

It should be noted that the method described herein describes A possible implementation, and that the operations and the steps may be rearranged or otherwise modified and that other implementations are possible.

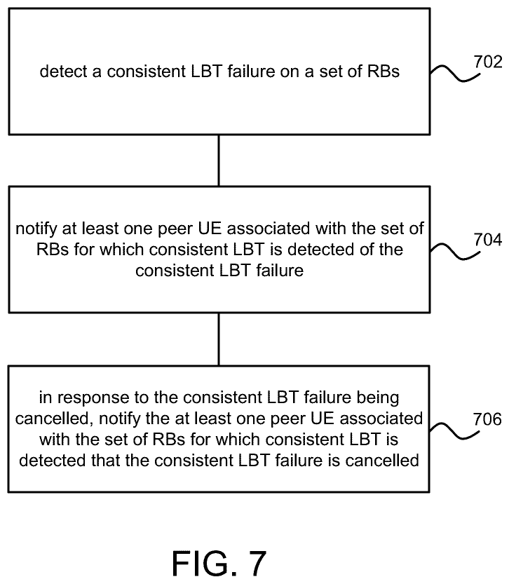

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include detecting a consistent LBT failure on a set of RBs. The operations of 702 may be performed in accordance with examples as described herein. In some implementations, aspects of the operations of 702 may be performed by a UE as described with reference to FIG. 3.

At 704, the method may include notifying at least one peer UE associated with the set of RBs for which consistent LBT is detected of the consistent LBT failure. The operations of 704 may be performed in accordance with examples as described herein. In some implementations, aspects of the operations of 704 may be performed by a UE as described with reference to FIG. 3.

At 706, the method may include, in response to the consistent LBT failure being cancelled, notify the at least one peer UE associated with the set of RBs for which consistent LBT is detected that the consistent LBT failure is cancelled. The operations of 706 may be performed in accordance with examples as described herein. In some implementations, aspects of the operations of 706 may be performed a UE as described with reference to FIG. 3.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
detect a consistent listen before talk (LBT) failure on a set of resource blocks (RBs);
perform at least one LBT on the set of RBs, wherein the LBT is performed based on a reference sidelink (SL) format;
increment a counter in response to determining a success for one of the at least one LBT, wherein the counter is associated with the set of RBs; and
in response to determining that the counter satisfies a predefined threshold, cancel the consistent LBT failure.

2. The UE of claim 1, wherein:
the reference SL format is comprised of a predefined channel access priority class.

3. The UE of claim 1, wherein:
the LBT based on a reference SL format is comprised of a fixed sensing duration.

4. The UE of claim 1, wherein:
the at least one LBT that is performed on the set of RBs based on the reference SL format is performed during a time window.

5. The UE of claim 4, wherein:
the time window begins a predefined time offset after having declared consistent LBT failure for the set of RBs.

6. The UE of claim 5, wherein:
the at least one LBT is performed at predefined occasions during the time window.

7. A processor for wireless communication, comprising:
at least one controller coupled with at least one memory and configured to cause the processor to:
detect a consistent listen before talk (LBT) failure on a set of resource blocks (RBs);
perform at least one LBT on the set of RBs, wherein the LBT is performed based on a reference sidelink (SL) format;
increment a counter in response to determining a success for one of the at least one LBT, wherein the counter is associated with the set of RBs; and
in response to determining that the counter satisfies a predefined threshold, cancel the consistent LBT failure.

8. The processor of claim 7, wherein:
the reference SL format is comprised of a predefined channel access priority class.

9. The processor of claim 7, wherein:
the LBT based on a reference SL format is comprised of a fixed sensing duration.

10. The processor of claim 7, wherein:
the at least one LBT that is performed on the set of RBs based on the reference SL format is performed during a time window.

11. The processor of claim 10, wherein:
the time window begins a predefined time offset after having declared consistent LBT failure for the set of RBs.

12. The processor of claim 11, wherein:
the at least one LBT is performed at predefined occasions during the time window.

13. A method performed by a user equipment (UE), the method comprising:
detecting a consistent listen before talk (LBT) failure on a set of resource blocks (RBs);
performing at least one LBT on the set of RBs, wherein the LBT is performed based on a reference sidelink (SL) format;
incrementing a counter in response to determining a success for one of the at least one LBT, wherein the counter is associated with the set of RBs; and
in response to determining that the counter satisfies a predefined threshold, cancelling the consistent LBT failure.

14. The method of claim 13, wherein:
the reference SL format is comprised of a predefined channel access priority class.

15. The method of claim 13, wherein:
the LBT based on a reference SL format is comprised of a fixed sensing duration.

16. The method of claim 13, wherein:
the at least one LBT that is performed on the set of RBs based on the reference SL format is performed during a time window.

17. The method of claim 16, wherein:
the time window begins a predefined time offset after having declared consistent LBT failure for the set of RBs.

18. The method of claim 17, wherein:
the at least one LBT is performed at predefined occasions during the time window.

19. A user equipment (UE) for wireless communication, comprising:
at least one memory; and
at least one processor coupled with the at least one memory and configured to cause the UE to:
detect a consistent listen before talk (LBT) failure on a set of resource blocks (RBs);
notify at least one peer UE associated with the set of RBs for which consistent LBT is detected of the consistent LBT failure; and
in response to the consistent LBT failure being cancelled, notify the at least one peer UE associated with the set of RBs for which consistent LBT is detected that the consistent LBT failure is cancelled.

20. The UE of claim 19, wherein:
the at least one processor is configured to cause the UE to notify the at least one peer UE of the consistent LBT failure as part of transmission of inter-UE coordination (IUC) information.
